(19) United States
(12) Patent Application Publication
(10) Pub. No.: US 2020/0386559 A1
(43) Pub. Date: Dec. 10, 2020

(54) TRAVELING CONTROL APPARATUS, VEHICLE, AND TRAVELING CONTROL METHOD

(71) Applicant: HONDA MOTOR CO., LTD., MINATO-KU, TOKYO (JP)

(72) Inventors: Masaaki NAGASHIMA, WAKO-SHI, SAITAMA-KEN (JP); Hideki MATSUNAGA, WAKO-SHI, SAITAMA-KEN (JP); Takeru GOTO, WAKO-SHI, SAITAMA-KEN (JP); Takumi MACHIDA, MINATO-KU, TOKYO (JP); Toshiaki TAKANO, MINATO-KU, TOKYO (JP)

(21) Appl. No.: 16/768,427

(22) PCT Filed: Dec. 1, 2017
(86) PCT No.: PCT/JP2017/043238

§ 371 Date: May 29, 2020

(51) Int. Cl. G01C 21/34; B60W 60/00

(52) U.S. Cl. CPC G01C 21/3461; B60W 60/0059; B60W 60/00253; B60W 60/0016

(57) ABSTRACT

Provided are a traveling control apparatus, a vehicle, and a traveling control method in which appropriateness of a user target destination can be taken into consideration. A vehicle target destination calculation unit sets a vehicle target destination where a vehicle is to be stopped, on the basis of a user target destination inputted by a user via a target destination input unit. Further, in the case where it is determined, on the basis of information about the road of the user target destination, that the user target destination is an inappropriate stopping point which is on the road but is unsuitable for stopping the vehicle, the vehicle target destination calculation unit sets an appropriate stopping point off track from the user target destination as a vehicle target destination.

### TECHNICAL FIELD

The present invention relates to a travel control device, a vehicle, and a travel control method (a traveling control apparatus, a vehicle, and a traveling control method) for causing a vehicle to travel autonomously in at least a part of a route to a destination.

### BACKGROUND ART

In International Publication No. WO 2011/158347 (hereinafter, referred to as “WO 2011/158347 A1”), an object is to provide a driving assistance device that allows a driver to easily operate intuitively without a sense of discomfort ([0008] and Abstract). In order to achieve this object, in WO 2011/158347 A1, when it is instructed to perform autonomous driving through an autonomous driving switch, an autonomous driving mode is switched depending on whether a destination has been set and the driver has the intention to continue the travel.

That is to say, in a case where a destination setting unit 3 has set the destination, a course for the autonomous driving to the destination is generated and the autonomous driving is started (Abstract and S12 in FIG. 2). In a case where the destination setting unit 3 has not set the destination and a travel intention detection unit 4 has detected that the driver has the intention to continue the travel, a course for the autonomous driving along the road is generated and the autonomous driving is started (Abstract and S16 in FIG. 2). In a case where the destination setting unit 3 has not set the destination and the travel intention detection unit 4 has detected that the driver does not have the intention to continue the travel, a course for autonomous stopping is generated and the autonomous driving is started (Abstract and S18 in FIG. 2).

The destination setting unit 3 is used by the driver to set the destination for the autonomous driving, and for example may be a touch screen of a navigation system ([0027]).

### SUMMARY OF INVENTION

As described above, in WO 2011/158347 A1, when the destination is set by the destination setting unit 3, the course for the autonomous driving to the destination is generated and the autonomous driving is started (Abstract, S12 in FIG. 2). However, WO 2011/158347 A1 merely discloses to use the destination (user destination) set by the driver (user) without any change. In other words, whether the user destination is adequate as a stop position (or the risk of the user destination) is not taken into consideration.

The present invention has been made in view of the above circumstance, and an object is to provide a travel control device, a vehicle, and a travel control method in which the adequateness of a user destination can be taken into consideration.

A travel control device according to the present invention includes: a vehicle destination calculation unit configured to set a vehicle destination where a vehicle stops on the basis of a user destination that is input by a user through a destination input unit; and a travel control unit configured to cause the vehicle to travel autonomously in at least a part of a route to the vehicle destination, wherein if it is determined that the user destination is positioned on a road but is a stop inadequate point that is inadequate for the vehicle to stop, on a basis of road information of the user destination, the vehicle destination calculation unit is configured to set a stop adequate point that is shifted from the user destination as the vehicle destination.

According to the present invention, if it is determined that the user destination is the stop inadequate point, the point shifted from the user destination is set as the vehicle destination. Thus, the vehicle can be stopped at the stop adequate point. Accordingly, it is possible to prevent the vehicle as an autonomous driving vehicle or the like from stopping at the inadequate position, and the user convenience can be improved.

The stop inadequate point may include a point in a railroad crossing, in an intersection, in a construction site, or in a periphery of these places. Thus, it is possible to prevent the vehicle from stopping in the railroad crossing, in the intersection, in the construction site, or in the periphery of these places.

A vehicle according to the present invention includes: the travel control device; and an automatic door, wherein if the user destination is the stop inadequate point, the vehicle destination calculation unit is configured to set a point where the automatic door faces the user destination as the vehicle destination, and when the vehicle arrives at the vehicle destination, the travel control device is configured to open the automatic door automatically.

Thus, the user who gets off the vehicle can go to the user destination easily.

A travel control method according to the present invention includes: a user destination receiving step of receiving a user destination from a user through a destination input unit; a vehicle destination setting step of causing a vehicle destination calculation unit to set a vehicle destination where a vehicle stops on a basis of the user destination; and a travel control step of causing a travel control unit to make the vehicle travel autonomously in at least a part of a route to the vehicle destination, wherein in the vehicle destination setting step, if the vehicle destination calculation unit determines that the user destination is positioned on a road but is a stop inadequate point that is inadequate for the vehicle to stop on a basis of road information of the user destination, the vehicle destination calculation unit is configured to set a stop adequate point that is shifted from the user destination as the vehicle destination.

### BRIEF DESCRIPTION OF DRAWINGS

FIG. 1 is a block diagram schematically illustrating a configuration of a vehicle according to one embodiment of the present invention;

FIG. 2 is a diagram illustrating each unit of a travel control device according to the embodiment;

FIG. 3 is a flowchart of autonomous driving control in the embodiment;

FIG. 4 is a flowchart in which a navigation device generates a target route in the embodiment (details of S12 in FIG. 3);

FIG. 5 is a diagram illustrating an example in which a user destination exists near a railroad crossing in the embodiment;

FIG. 6 is a diagram illustrating an example in which the user destination exists near an intersection in the embodiment; and

FIG. 7 is a flowchart in which the navigation device selects an alternative place in the embodiment (details of S25 in FIG. 4).

### DESCRIPTION OF EMBODIMENT

### A. Embodiment

### A-1. Configuration

### [A-1-1. Summary]

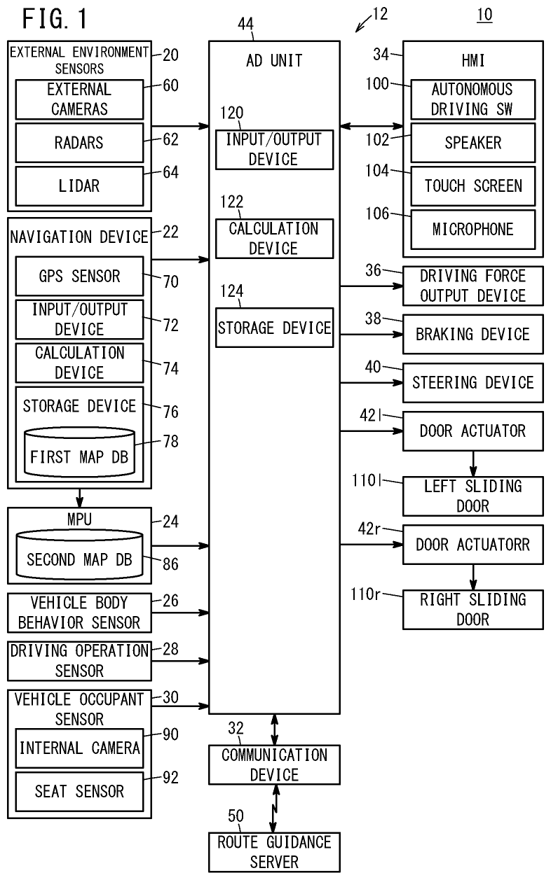

FIG. 1 is a block diagram schematically illustrating a configuration of a vehicle 10 according to one embodiment of the present invention. The vehicle 10 (hereinafter also referred to as “user's own vehicle 10”) includes external environment sensors 20, a navigation device 22, a map positioning unit 24 (hereinafter referred to as “MPU 24”), a vehicle body behavior sensor 26, a driving operation sensor 28, a vehicle occupant sensor 30, a communication device 32, a human-machine interface 34 (hereinafter referred to as “HMI 34”), a driving force output device 36, a braking device 38, a steering device 40, door actuators 421, 42r, and an AD unit 44. The term “AD” of the AD unit 44 is the abbreviation for autonomous driving. The navigation device 22, the MPU 24, and the AD unit 44 form a travel control device 12.

### [A-1-2. External Environment Sensors 20]

The external environment sensors 20 detect information about the external environment around the vehicle 10 (hereinafter this information is also referred to as “external environment information Ie”). The external environment sensors 20 include a plurality of external cameras 60, a plurality of radars 62, and a LIDAR (Light Detection And Ranging) 64.

The external cameras 60 capture images around the vehicle 10 (front, side, and rear) to obtain peripheral images Fs, and output image information Iimage about the peripheral images Fs. The radars 62 output radar information Iradar expressing reflection waves of electromagnetic waves that have been transmitted to the periphery of the vehicle 10 (front, side, and rear). The LIDAR 64 continuously outputs lasers in all directions of the vehicle 10, measures a three-dimensional position of a reflection point on the basis of the reflection waves of the output lasers, and outputs three-dimensional information Ilidar.

### [A-1-3. Navigation Device 22]

The navigation device 22 calculates a target route Rtar from a current position Pcur to a destination Ptar, shows the target route Rtar to a vehicle occupant, and outputs the target route Rtar to the MPU 24. As illustrated in FIG. 1, the navigation device 22 includes a global positioning system sensor 70 (hereinafter referred to as “GPS sensor 70”), an input/output device 72, a calculation device 74, and a storage device 76.

The GPS sensor 70 detects the current position Pcur of the vehicle 10. The input/output device 72 performs input/output with the units (MPU 24, AD unit 44, and the like) other than the navigation device 22. The calculation device 74 performs target route calculation control, that is, calculates the target route Rtar from the current position Pcur to the destination Ptar. The destination Ptar is input by the user through the HMI 34 (particularly, touch screen 104 or microphone 106).

In addition, the calculation device 74 reads out map information Imap corresponding to the current position Pcur detected by the GPS sensor 70 from a first map database 78 (hereinafter referred to as “first map DB 78”) in the storage device 76 and calculates the target route Rtar using the map information Imap.

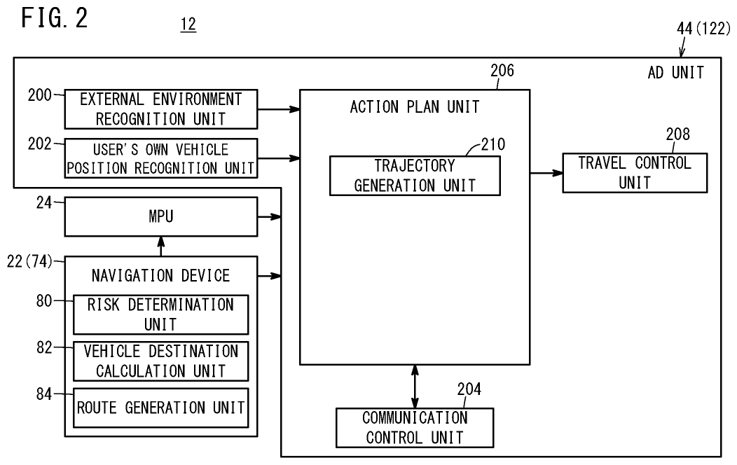

FIG. 2 illustrates each unit of the travel control device 12 according to the present embodiment. As illustrated in FIG. 2, the calculation device 74 includes a risk determination unit 80, a vehicle destination calculation unit 82, and a route generation unit 84. The risk determination unit 80 determines a risk R (details are described below) of the destination Ptar that is input by the user through the HMI 34 (this destination is hereinafter also referred to as “user destination Putar”). The vehicle destination calculation unit 82 calculates the destination Ptar (hereinafter also referred to as “vehicle destination Pvtar” where the vehicle 10 actually stops, on the basis of the user destination Putar, the map information Imap in the first map DB 78, and the risk R. The route generation unit 84 generates the target route Rtar from the current position Pcur to the vehicle destination Pvtar. While the autonomous driving control is performed, the route generation unit 84 transmits the target route Rtar to the MPU 24.

The storage device 76 stores the first map DB 78, and programs and data that are used by the calculation device 74. The storage device 76 includes, for example, a random access memory (hereinafter referred to as “RAM”). As the RAM, a volatile memory such as a register, and a nonvolatile memory such as a flash memory can be used. In addition to the RAM, the storage device 76 may include a read only memory (hereinafter referred to as “ROM”) and/or a solid state drive (hereinafter referred to as “SSD”).

### [A-1-4. MPU 24]

The MPU 24 manages a second map database 86 (hereinafter referred to as “second map DB 86”). The map information Imap stored in the second map DB 86 is more precise than the map information Imap in the first map DB 78, and the accuracy of position in the second map DB 86 is less than or equal to centimeters. While the first map DB 78 does not include the detailed information about the lanes of the roads, the second map DB 86 includes the detailed information about the lanes of the roads. The MPU 24 reads, from the second map DB 86, the map information Imap (high-precision map) corresponding to the target route Rtar received from the navigation device 22, and transmits the map information Imap to the AD unit 44. The map information Imap (high-precision map) corresponding to a target trajectory Ltar is used in the autonomous driving control.

### [A-1-5. Vehicle Body Behavior Sensor 26]

The vehicle body behavior sensor 26 detects information about the behavior of the vehicle 10 (vehicle body in particular) (hereinafter this information is also referred to as “vehicle body behavior information Ib”). The vehicle body behavior sensor 26 includes a vehicle speed sensor, an acceleration sensor, and a yaw rate sensor (none of them are shown). The vehicle speed sensor detects a vehicle speed V [km/h] and the traveling direction of the vehicle 10. The acceleration sensor detects an acceleration G [m/s/s] of the vehicle 10. The acceleration G includes a longitudinal acceleration α, a lateral acceleration Glat, and a vertical acceleration Gv (or may be any one of these accelerations). The yaw rate sensor detects a yaw rate Y [rad/s] of the vehicle 10.

### [A-1-6. Driving Operation Sensor 28]

The driving operation sensor 28 detects information regarding driving operation of a driver (this information is hereinafter also referred to as “driving operation information Ido”). The driving operation sensor 28 includes an accelerator pedal sensor and a brake pedal sensor (neither are shown). The accelerator pedal sensor detects the operation amount [%] of an accelerator pedal that is not shown. The brake pedal sensor detects the operation amount [%] of a brake pedal that is not shown. The driving operation sensor 28 may include a steering angle sensor and a steering torque sensor (neither are shown), for example.

### [A-1-7. Vehicle Occupant Sensor 30]

The vehicle occupant sensor 30 detects information regarding the state of the vehicle occupant (not related to the driving operation directly) (this information is hereinafter also referred to as “vehicle occupant information Io”). The vehicle occupant sensor 30 includes an internal camera 90 and a seat sensor 92. The internal camera 90 is a driver monitoring camera that captures the driver's face and a periphery thereof. The seat sensor 92 is a pressure sensor provided to a seat cushion that is not shown. The vehicle occupant sensor 30 may include a seat belt sensor that detects whether the vehicle occupant wears a seat belt that is not shown.

### [A-1-8. Communication Device 32]

The communication device 32 communicates wirelessly with external devices. Examples of the external devices include a route guidance server 50. It is assumed that the communication device 32 according to the present embodiment is mounted (or normally fixed) in the vehicle 10; however, for example, the communication device 32 may be carried out of the vehicle 10 like a mobile phone or a smart phone.

### [A-1-9. HMI 34]

The HMI 34 (destination input unit) receives an operation input from the vehicle occupant, and shows various pieces of information to the vehicle occupant visually, audibly, and haptically. The HMI 34 includes an autonomous driving switch 100 (hereinafter also referred to as “autonomous driving SW 100”), a speaker 102, the touch screen 104, and the microphone 106.

The autonomous driving SW 100 is a switch for the vehicle occupant to order start or stop of the autonomous driving control. In addition to or instead of the autonomous driving SW 100, another method (for example, voice input through microphone 106) may be employed to order start or stop of the autonomous driving control. The touch screen 104 includes, for example, a liquid crystal panel or an organic EL panel.

### [A-1-10. Driving Force Output Device 36]

The driving force output device 36 includes a travel driving source (an engine, a traction motor, or the like) and a driving electronic control unit (hereinafter referred to as “driving ECU”) that are not shown. The driving ECU controls the travel driving source on the basis of the operation amount of the accelerator pedal or the instruction from the AD unit 44 so as to adjust the travel driving force of the vehicle 10.

### [A-1-11. Braking Device 38]

The braking device 38 includes a brake motor (or hydraulic mechanism), a brake member, and a braking electronic control unit (hereinafter referred to as “braking ECU”) that are not shown. The braking device 38 may control engine braking by an engine and/or regenerative braking by a travel motor. The braking ECU controls the braking force of the vehicle 10 by operating the brake motor or the like on the basis of the operation amount of the brake pedal or the instruction from the AD unit 44.

### [A-1-12. Steering Device 40]

The steering device 40 includes an electric power steering (EPS) motor and an EPS electronic control unit (hereinafter referred to as “EPS ECU”) that are not shown. The EPS ECU controls the EPS motor in accordance with the driver's operation of a steering wheel or the instruction from the AD unit 44 so as to control the steering angle of the vehicle 10.

[A-1-13. Door Actuators 421, 42r]

The door actuator 421 automatically opens/closes a left sliding door 1101 on the basis of the instruction from the AD unit 44. The door actuator 42r automatically opens/closes a right sliding door 110r on the basis of the instruction from the AD unit 44.

### [A-1-14. AD Unit 44]

### (A-1-14-1. Summary of AD Unit 44)

The AD unit 44 performs the autonomous driving control for driving the vehicle 10 to the destination Ptar without requiring the driver's driving operation (acceleration, deceleration, and steering), and includes, for example, a central processing unit (CPU). The AD unit 44 includes an input/output device 120, a calculation device 122, and a storage device 124.

The input/output device 120 performs input/output with the devices other than the AD unit 44 (sensors 20, 26, 28, 30, etc.). The calculation device 122 performs calculation on the basis of signals from the sensors 20, 26, 28, 30, the navigation device 22, the MPU 24, the communication device 32, the HMI 34, and the like. The calculation device 122 generates signals for the communication device 32, the HMI 34, the driving force output device 36, the braking device 38, and the steering device 40 on the basis of a calculation result. The details of the calculation device 122 are described below with reference to FIG. 2.

The storage device 124 stores programs and data that are used by the calculation device 122. The storage device 124 includes, for example, a RAM. In addition to the RAM, the storage device 124 may include a ROM and/or an SSD.

### (A-1-14-2. Calculation Device 122)

As illustrated in FIG. 2, the calculation device 122 in the AD unit 44 includes an external environment recognition unit 200, a user's own vehicle position recognition unit 202, a communication control unit 204, an action plan unit 206, and a travel control unit 208. These units are achieved when, for example, the calculation device 122 (CPU, for example) executes the programs stored in the storage device 124 in the AD unit 44. The programs may be supplied from an external management server (not shown) through the communication device 32. A part of the programs may be formed by hardware (circuit component).

The external environment recognition unit 200 recognizes the circumstances and objects around the user's own vehicle 10 on the basis of the external environment information Ie from the external environment sensors 20 (FIG. 1). The external environment recognition unit 200 recognizes an overall road environment such as a road shape, a road width, a position of a lane mark, the number of lanes, a lane width, a lighting state of a traffic signal, and an open/close state of a crossing gate on the basis of the image information Iimage from the external cameras 60.

The user's own vehicle position recognition unit 202 recognizes the current position Pcur of the user's own vehicle 10 with high accuracy on the basis of the recognition result from the external environment recognition unit 200, the map information Imap from the MPU 24, and the current position Pcur from the navigation device 22. The communication control unit 204 controls the communication between the AD unit 44 and the devices outside the vehicle (for example, route guidance server 50).

The action plan unit 206 determines the travel circumstance of the user's own vehicle 10 on the basis of the map information Imap (high-precision map) from the MPU 24, the recognition results from the external environment recognition unit 200 and the user's own vehicle position recognition unit 202, and a detection result from the vehicle body behavior sensor 26, and decides various actions of the user's own vehicle 10. Specifically, the action plan unit 206 calculates the target trajectory Ltar, the target vehicle speed Vtar, and the like.

As illustrated in FIG. 2, the action plan unit 206 includes a trajectory generation unit 210. The trajectory generation unit 210 generates the target trajectory Ltar to the vehicle destination Pvtar, and causes the vehicle 10 to travel autonomously to the vehicle destination Pvtar.

The target route Rtar calculated by the navigation device 22 is used to show the driver the road to advance, and is relatively rough. On the other hand, the target trajectory Ltar calculated by the action plan unit 206 includes, in addition to the rough trajectory calculated by the navigation device 22, a relatively precise content for controlling the acceleration, deceleration, and steering of the vehicle 10.

The travel control unit 208 calculates a control instruction for the driving force output device 36, the braking device 38, and the steering device 40 on the basis of a decision result of the action plan unit 206 (target trajectory Ltar, target speed, or the like), and transmits the control instruction thereto. In other words, the travel control unit 208 controls the output of each actuator that controls the vehicle body behavior. The actuator herein described includes an engine, a brake motor, an EPS motor, and the like. The travel control unit 208 controls the output of the actuator so as to control the amount of behavior of the vehicle 10 (particularly, vehicle body) (hereinafter this amount is referred to as “vehicle body behavior amount Qb”). The vehicle body behavior amount Qb herein described includes, for example, the vehicle speed V, the longitudinal acceleration α, a steering angle θst, the lateral acceleration Glat, and the yaw rate Y.

### [A-1-15. Route Guidance Server 50]

The route guidance server 50 generates or calculates the target route Rtar to the destination Ptar instead of the vehicle 10 on the basis of the current position Pcur of the vehicle 10 and the destination Ptar that are received from the communication device 32. The route guidance server 50 includes an input/output device, a communication device, a calculation device, and a storage device that are not shown. The storage device stores programs and data that are used by the calculation device.

### A-2. Control in the Present Embodiment

### [A-2-1. Summary]

The vehicle 10 according to the present embodiment can perform the autonomous driving control for causing the vehicle 10 to travel autonomously to the destination Ptar. The autonomous driving control is performed by the navigation device 22, the MPU 24, and the AD unit 44 (that is, the travel control device 12).

In the present embodiment, in the case where the destination Ptar designated by the user (user destination Putar) is the point that is on the road but is inadequate for the vehicle to stop (stop inadequate point Pia), a point shifted from the user destination Putar is set as the actual destination Ptar (vehicle destination Pvtar). In the case where the user destination Putar is a point adequate for the vehicle to stop (stop adequate point Pad), the user destination Putar is kept as the vehicle destination Pvtar.

### [A-2-2. Autonomous Driving Control]

### (A-2-2-1. Summary)

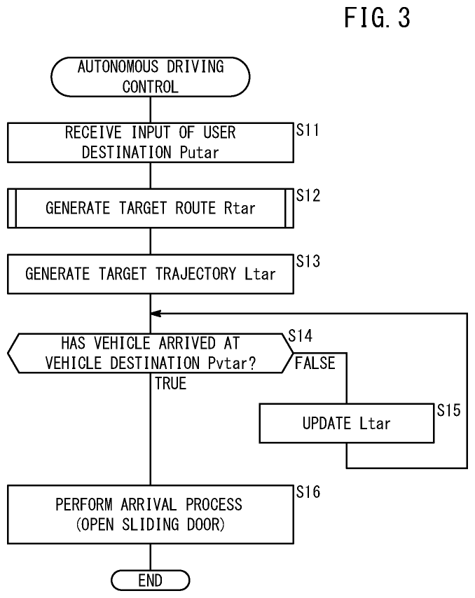

FIG. 3 is a flowchart of the autonomous driving control in the present embodiment. In step S11, the navigation device 22 receives the input of the destination Ptar (user destination Putar) from the user through the HMI 34 (touch screen 104, microphone 106, etc.). The user destination Putar that is input may be a portion with an area in the first map DB 78 (for example, facility name, address). The user destination Putar as the portion with the area includes a reference coordinate that is defined as a point. The reference coordinate is specified as an XY coordinate.

Alternatively, the user destination Putar may be a portion that is defined as a point in the first map DB 78. The user destination Putar that is defined as the point is set as a point that the user is in contact with, or the user designates with a cursor on a map screen (not shown) that is displayed on the touch screen 104.

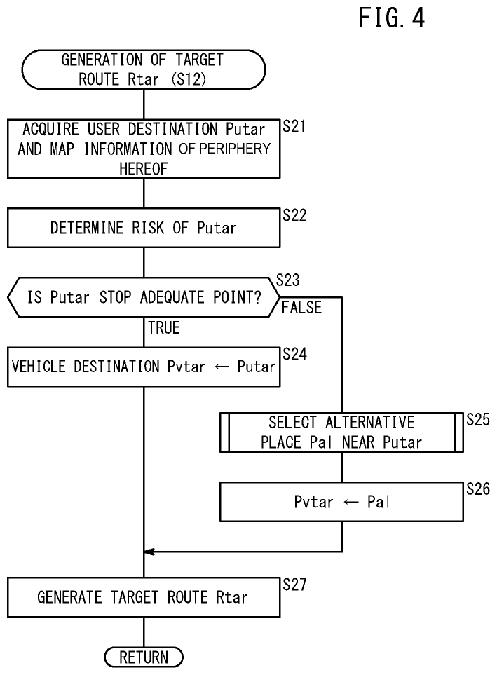

In step S12, the navigation device 22 sets the vehicle destination Pvtar on the basis of the user destination Putar, and generates the target route Rtar from the current position Pcur to the vehicle destination Pvtar (details are described below with reference to FIG. 4). In addition, the navigation device 22 notifies the MPU 24 of the generated target route Rtar.

Note that the vehicle destination Pvtar here is the portion that is defined as the point in the first map DB 78, and the XY coordinate of this portion is specified. However, the vehicle destination Pvtar may be defined as a portion with an area (for example, region with length and width of several meters). In this case, it is necessary to set a reference point for generating the target route Rtar.

In step S13, the MPU 24 reads, from the second map DB 86, the map information Imap (high-precision map) corresponding to the target route Rtar received from the navigation device 22, and transmits the map information Imap to the AD unit 44. The AD unit 44 generates the target trajectory Ltar on the basis of the map information Imap (high-precision map) from the MPU 24, and the recognition results from the external environment recognition unit 200 and the user's own vehicle position recognition unit 202. Then, the AD unit 44 controls the driving force output device 36, the braking device 38, the steering device 40, and the like on the basis of the target trajectory Ltar.

Note that in the present embodiment, the target route Rtar expresses the relatively long trajectory from the current position Pcur to the vehicle destination Pvtar, and the target trajectory Ltar expresses the relatively short trajectory that is required to autonomously drive the vehicle 10. However, the target route Rtar and the target trajectory Ltar may be used altogether.

In step S14, the AD unit 44 determines whether the user's own vehicle 10 has arrived at the vehicle destination Pvtar. If the user's own vehicle 10 has not arrived at the vehicle destination Pvtar (S14: FALSE), the AD unit 44 updates the target trajectory Ltar in step S15 and the process returns to step S14. If the user's own vehicle 10 has arrived at the vehicle destination Pvtar (S14: TRUE), the AD unit 44 performs an arrival process in step S16 (details are described below).

### (A-2-2-2. Generation of Target Route Rtar (S12 in FIG. 3))

### (A-2-2-2-1. Summary)

FIG. 4 is a flowchart in which the navigation device 22 generates the target route Rtar in the present embodiment (details of S12 in FIG. 3). In step S21, the navigation device 22 acquires the user destination Putar and the map information Imap of the periphery of the user destination Putar from the first map DB 78.

In step S22, the navigation device 22 determines the risk R of the user destination Putar received in step S11 in FIG. 3. The risk R is the information expressing whether the user destination Putar is the point Pad adequate for the vehicle to stop (hereinafter also referred to as “stop adequate point Pad”) or the point Pia inadequate for the vehicle to stop (hereinafter also referred to as “stop inadequate point Pia”).

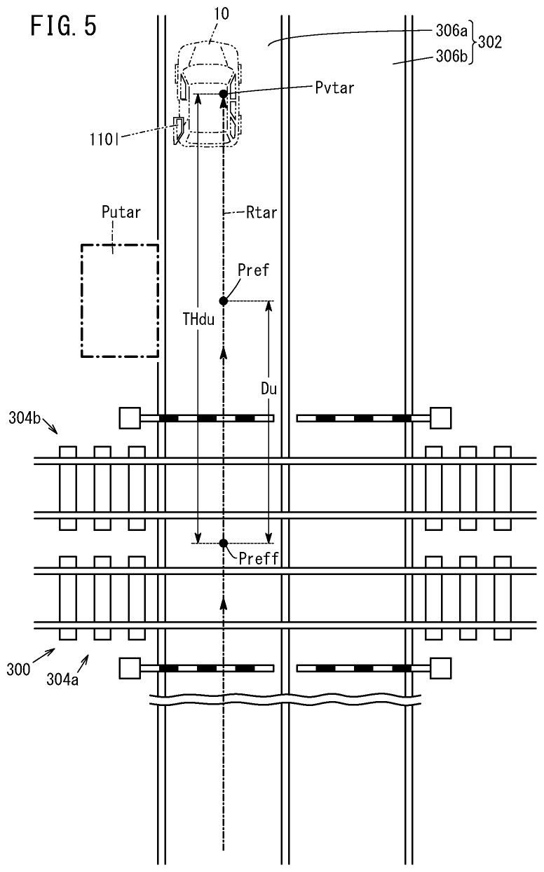

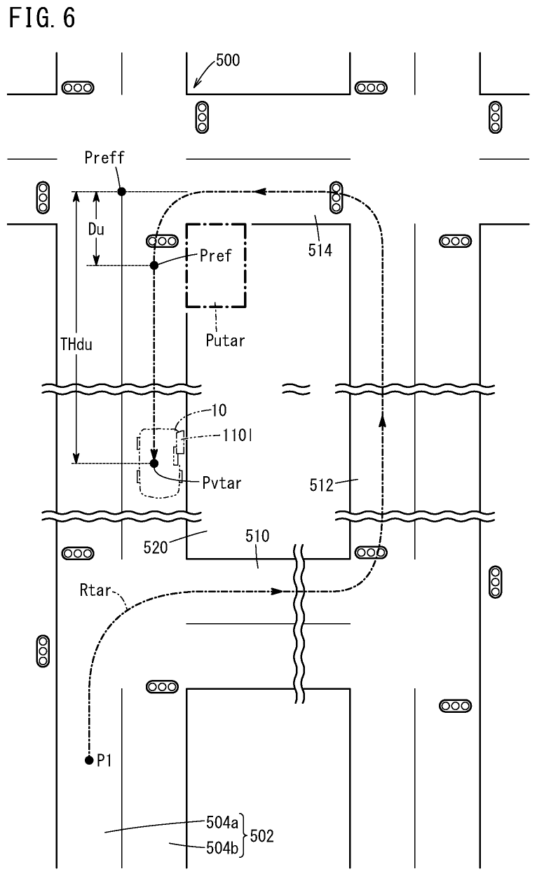

For example, the navigation device 22 determines whether the user destination Putar is in a railroad crossing 300 (FIG. 5), in an intersection 500 (FIG. 6), in a construction site, or in the periphery of these places. Whether the user destination Putar is in “the periphery” of these places is determined on the basis of, for example, whether a distance Du between the user destination Putar and a reference position Preff of each of the railroad crossing 300, the intersection 500, and the construction site is within a distance threshold THdu.

If it is determined that the user destination Putar is not in the railroad crossing 300, in the intersection 500, in the construction site, or in the periphery of these places, the navigation device 22 determines that the user destination Putar is the stop adequate point Pad (sets the risk R expressing this determination). If it is determined that the user destination Putar is in the railroad crossing 300, in the intersection 500, in the construction site, or in the periphery of these places, the navigation device 22 determines that the user destination Putar is the stop inadequate point Pia (sets the risk R expressing this determination).

Even in the case where it is determined that the user destination Putar is in the periphery of the railroad crossing 300, the intersection 500, or the construction site, the navigation device 22 may determine that the user destination Putar is the stop adequate point Pad if there is a parking lot.

The stop adequate point Pad and the stop inadequate point Pia are both positioned on the road. If the user designates a place that is not on the road, for example a lake, the navigation device 22 sets a point on the road based on the point designated by the user (for example, the point on the road closest to the user designated point) as the user destination Putar. The term “on the road” herein described means not just the point in the lane of the road but also a region expressing a facility facing the road.

If the user destination Putar is the stop adequate point Pad (S23 in FIG. 4: TRUE), the navigation device 22 keeps the user destination Putar as the vehicle destination Pvtar in step S24. If the user destination Putar is not the stop adequate point Pad (S23 in FIG. 4: FALSE), in other words, if the user destination Putar is the stop inadequate point Pia, the process advances to step S25.

In step S25, the navigation device 22 selects an alternative place Pal near the user destination Putar (details are described below with reference to FIG. 5 to FIG. 7). In step S26, the navigation device 22 sets the alternative place Pal as the vehicle destination Pvtar.

After step S24 or S26, the navigation device 22 generates the target route Rtar from the current position Pcur of the user's own vehicle 10 to the vehicle destination Pvtar using the map information Imap of the first map DB 78 in step S27. When the target route Rtar is calculated, for example, the route that takes the shortest time is selected.

### (A-2-2-2-2. Selection of Alternative Place Pal (S25 in FIG. 4))

FIG. 5 and FIG. 6 are first and second explanatory diagrams for describing the generation of the alternative place Pal by the navigation device 22 according to the present embodiment. FIG. 5 and FIG. 6 each illustrate the periphery of the vehicle destination Pvtar (user destination Putar or alternative place Pal), and the vehicle 10 is illustrated with a two-dot chain line at the vehicle destination Pvtar. However, it should be noted that the alternative place Pal (and vehicle destination Pvtar) is generated or calculated when the user destination Putar is set (see FIG. 4) in the present embodiment. Therefore, when the alternative place Pal (and vehicle destination Pvtar) is generated or calculated, the vehicle 10 does not exist near the vehicle destination Pvtar.

The map information Imap of the first map DB 78 used to calculate the target route Rtar is relatively rough and shown with nodes (dots) and edges (lines). Therefore, it should be noted that the map information Imap used to calculate the target route Rtar does not contain information as specific as the information in FIG. 5 or FIG. 6.

As described above, if the user destination Putar is not the stop adequate point Pad (S23 in FIG. 4: FALSE), the alternative place Pal near the user destination Putar is selected.

FIG. 5 is a diagram illustrating an example in which the user destination Putar exists near the railroad crossing 300 in the present embodiment. In FIG. 5, the railroad crossing 300 exists near the user destination Putar. The reference position Preff of the railroad crossing 300 is stored in the first map DB 78 as the node (dot). At the railroad crossing 300, a road 302 with one lane on each side crosses with two railroads 304a, 304b.

In the present embodiment, the vehicle 10 keeps left and from the viewpoint of the vehicle 10, a left lane 306a is a travel lane and a right lane 306b is an opposite lane. In the first map DB 78, the lanes 306a, 306b are stored as edges (lines) and the railroad crossing 300 is stored as a node (dot). On the other hand, information about the railroads 304a, 304b is not stored in the first map DB 78.

In the example in FIG. 5, the user destination Putar exists over the railroad crossing 300, and a reference position Pref is set on the right side thereof and on the travel lane 306a. The distance Du between the reference position Preff of the railroad crossing 300 and the reference position Pref of the user destination Putar is less than the distance threshold THdr. Therefore, the vehicle destination Pvtar is set at the distance threshold THdr or more from the reference position Preff of the railroad crossing 300.

FIG. 6 is a diagram illustrating an example in which the user destination Putar exists near the intersection 500 in the present embodiment. In the example in FIG. 6, the user destination Putar exists around the intersection 500, and the reference position Pref is set on the left side thereof and on a lane 504b. The distance Du between the reference position Preff of the intersection 500 and the reference position Pref of the user destination Putar is less than the distance threshold THdu. Therefore, the vehicle destination Pvtar is set at the distance threshold THdu or more from the reference position Preff of the intersection 500.

In FIG. 6, a road 502 where the user's own vehicle 10 is scheduled to travel includes one lane on each side, and includes a travel lane 504a for the user's own vehicle 10 and the opposite lane 504b. When a point P1 on the target route Rtar of the user's own vehicle 10 and on the road 502 is employed as a reference, the travel lane 504a does not face the user destination Putar and the opposite lane 504b faces the user destination Putar. Thus, the vehicle 10 sets the vehicle destination Pvtar not along the travel lane 504a but along the opposite lane 504b. That is to say, the user's own vehicle 10 passes detours 510, 512, 514 and moves to the opposite lane 504b.

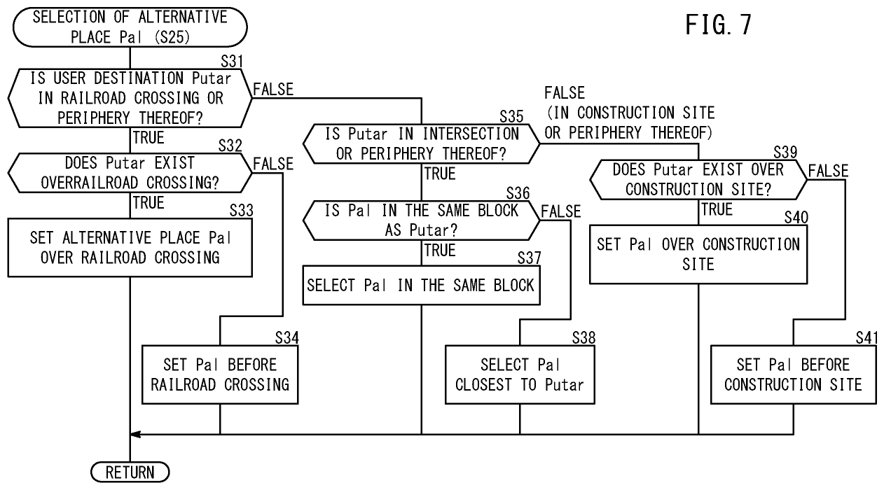

FIG. 7 is a flowchart in which the navigation device 22 selects the alternative place Pal in the present embodiment (details of S25 in FIG. 4). In step S31 in FIG. 7, the navigation device 22 determines whether the user destination Putar exists in the railroad crossing 300 or in the periphery thereof. If the user destination Putar exists in the railroad crossing 300 or in the periphery thereof (S31: TRUE), the navigation device 22 determines whether the user destination Putar exists over the railroad crossing 300 in step S32. If the user destination Putar exists over the railroad crossing 300 (S32: TRUE), the navigation device 22 sets the alternative place Pal over the railroad crossing 300 in step S33.

In this case, if the alternative place Pal is not a parking lot, the alternative place Pal is set on the lane side that faces the user destination Putar (see FIG. 5). In Japan where the vehicle 10 keeps left, stopping the vehicle 10 with the user destination Putar on the left side in the traveling direction of the vehicle 10 allows the user to go out of the vehicle 10 to the user destination Putar without crossing the road. For this reason, the alternative place Pal is set on the lane side that faces the user destination Putar (that is closer to the user destination Putar).

In addition, if the alternative place Pal is not a parking lot, the place whose distance Du from the railroad crossing 300 is the distance threshold THdu or more and that is closest to the user destination Putar is set as the alternative place Pal (see FIG. 5). Thus, the distance for which the user needs to walk from the vehicle 10 to the user destination Putar is the shortest.

If the user destination Putar does not exist over the railroad crossing 300 (S32: FALSE), the navigation device 22 sets the alternative place Pal before the railroad crossing 300 in step S34. In this case, in a manner similar to step S33, if the alternative place Pal is not a parking lot, the alternative place Pal is set on the lane side that faces the user destination Putar. In addition, if the alternative place Pal is not a parking lot, the place whose distance Du from the railroad crossing 300 is the distance threshold THdu or more and that is closest to the user destination Putar is set as the alternative place Pal. In FIG. 5, the reference position Preff of the railroad crossing 300 is set at the center of the railroad crossing 300 and on the travel lane 306.

Back to step S31, if the user destination Putar does not exist in the railroad crossing 300 or in the periphery thereof (S31: FALSE), the navigation device 22 determines whether the user destination Putar exists in the intersection 500 or in the periphery thereof in step S35. If the user destination Putar exists in the intersection 500 or in the periphery thereof (S35: TRUE), the navigation device 22 determines whether the alternative place Pal is in a block 520 (FIG. 6) that is same as the user destination Putar in step S36.

If the alternative place Pal is in the same block 520 (S36: TRUE), the navigation device 22 selects the alternative place Pal in the same block 520 in step S37. In this case, if there is a plurality of alternative places Pal, the alternative place that is closest to the user destination Putar is selected.

If the alternative place Pal is not in the same block 520 (S36: FALSE), the navigation device 22 selects the alternative place Pal closest to the user destination Putar (outside the block 520) in step S38.

Back to step S35, if the user destination Putar does not exist in the intersection 500 or in the periphery thereof (S35: FALSE), the place remaining as the stop inadequate point Pia is the place in the construction site or in the periphery thereof. In this case, in step S39, the navigation device 22 determines whether the user destination Putar exists over the construction site.

If the user destination Putar exists over the construction site (S39: TRUE), the navigation device 22 sets the alternative place Pal over the construction site in step S40. If the user destination Putar does not exist over the construction site (S39: FALSE), the navigation device 22 sets the alternative place Pal before the construction site in step S41.

In steps S40 and S41, the alternative place Pal can be set in a manner similar to steps S33 and S34. That is to say, if the alternative place Pal is not a parking lot, the alternative place Pal is set on the lane side that faces the user destination Putar. If the alternative place Pal is not a parking lot, the place whose distance Du from the construction site is the distance threshold THdu or more and that is closest to the user destination Putar is set as the alternative place Pal. In this case, the alternative place Pal is selected depending on whether the user destination Putar exists over or before the construction site.

### (A-2-2-3. Arrival Process (S16 in FIG. 3))

If the vehicle 10 has arrived at the vehicle destination Pvtar (S14 in FIG. 3: TRUE), the AD unit 44 performs the arrival process in step S16. In the arrival process, the target trajectory Ltar is set so that the vehicle destination Pvtar comes left (if vehicles keep left), and then the vehicle 10 is stopped. When the vehicle 10 has arrived at the vehicle destination Pvtar, the AD unit 44 operates the door actuator 421 to open the left sliding door 1101. In FIG. 5 and FIG. 6, the vehicle 10 illustrated with a dashed line at the vehicle destination Pvtar has the left sliding door 1101 open.

Note that in a case where the vehicle 10 includes front seats (driver's seat and passenger's seat) and rear seats and the sliding door 1101 is disposed for the rear seat, when the detection result from the vehicle occupant sensor 30 indicates the presence of the vehicle occupant only in the driver's seat, the AD unit 44 may keep the sliding door 1101 closed.

### A-3. Effects of the Present Embodiment

As described above, in the present embodiment, if it is determined that the user destination Putar is not the stop adequate point Pad (S23 in FIG. 4: FALSE), that is, the user destination Putar is the stop inadequate point Pia, the point shifted from the user destination Putar is set as the vehicle destination Pvtar (S25, S26 in FIG. 4). Thus, the vehicle 10 can be stopped at the stop adequate point Pad. Accordingly, it is possible to prevent the autonomous driving vehicle or the like from stopping at the inadequate position, and the user convenience can be improved.

In the present embodiment, the stop inadequate point Pia includes the point in the railroad crossing 300, in the intersection 500, in the construction site, or in the periphery of these places (FIG. 5 to FIG. 7). Thus, it is possible to prevent the vehicle 10 from stopping in the railroad crossing 300, in the intersection 500, in the construction site, or in the periphery of these places.

In the present embodiment, the vehicle 10 includes the travel control device 12 and the sliding door 1101 (automatic door) (FIG. 1). If the user destination Putar is the stop inadequate point Pia (S23 in FIG. 4: FALSE), the vehicle destination calculation unit 82 sets, as the vehicle destination Pvtar, the point where the sliding door 1101 faces the user destination Putar (FIG. 5 and FIG. 6). When the vehicle 10 has arrived at the vehicle destination Pvtar (S14 in FIG. 3: TRUE), the AD unit 44 opens the sliding door 1101 automatically (S16 in FIG. 3, FIG. 5, and FIG. 6). Thus, the user who gets off the vehicle 10 can go to the user destination Putar easily.

### B. Modifications

The present invention is not limited to the above embodiment, and various configurations can be employed on the basis of the content of the present specification. For example, the following configuration can be employed.

### B-1. Application Object

In the present embodiment, the vehicle 10 in which the travel control device 12 is used is a car (FIG. 5 and FIG. 6). However, for example, the vehicle 10 is not limited to a car from the viewpoint of, if the user destination Putar is the stop inadequate point Pia, setting the stop adequate point Pad shifted from the user destination Putar as the vehicle destination Pvtar. For example, the travel control device 12 may be used for vehicles (or movable bodies) such as trains, ships, and aircrafts.

### B-2. Vehicle 10

### [B-2-1. Automatic Door]

In the aforementioned embodiment, the vehicle 10 includes the left sliding door 1101 and the right sliding door 110r (FIG. 1). However, for example, from the viewpoint of automatically opening the door on the side opposite to the opposite lane 306b, 504b when the vehicle stops 10, the right sliding door 110r may be omitted and only the left sliding door 1101 may be provided (in the case where vehicles keep left).

In the above embodiment, the sliding doors 1101, 110r are used as the automatic doors (FIG. 1). However, for example, the present invention is not limited to this example from the viewpoint of the door that can be opened and closed automatically. For example, a folding door (door that is used in a bus), a gull-wing door, or the like can be used instead of the sliding doors 1101, 110r.

In the above embodiment, the sliding doors 1101, 110r are provided to the vehicle 10 as the automatic doors (FIG. 1). However, for example, the present invention is not limited to this example from the viewpoint of, if the user destination Putar is the stop inadequate point Pia, setting the stop adequate point Pad shifted from the user destination Putar as the vehicle destination Pvtar. For example, the vehicle 10 may exclude the automatic door.

### [B-2-2. Autonomous Driving Control]

In the above embodiment, the vehicle 10 keeps left (FIG. 5 and FIG. 6). However, for example, from the viewpoint of, if the user destination Putar is the stop inadequate point Pia, setting the stop adequate point Pad shifted from the user destination Putar as the vehicle destination Pvtar, the present invention is also applicable in the case where the vehicle 10 keeps right.

In the above embodiment, whether the user destination Putar is the stop adequate point Pad or the stop inadequate point Pia is determined on the basis of the map information Imap stored in advance in the first map DB 78 (S21, S22 in FIG. 4). However, for example, the present invention is not limited to this example from the viewpoint of acquiring road information for determining whether the user destination Putar is the stop adequate point Pad or the stop inadequate point Pia. For example, if an external monitor camera exists near the user destination Putar, the presence or absence of the railroad crossing 300 or the like may be determined using an image from the external monitor camera; thus, whether the user destination Putar is the stop adequate point Pad or the stop inadequate point Pia can be determined.

In the above embodiment, whether the user destination Putar is the stop adequate point Pad or the stop inadequate point Pia is determined by the navigation device 22 (S21, S22 in FIG. 4). However, for example, the present invention is not limited to this example from the viewpoint of determining whether the user destination Putar is the stop adequate point Pad or the stop inadequate point Pia. For example, this determination may be performed by the MPU 24 or the AD unit 44.

In the above embodiment, when the vehicle 10 has arrived at the vehicle destination Pvtar (S14 in FIG. 3: TRUE), the sliding door 1101 is opened in the arrival process (S16 in FIG. 3, FIG. 5, and FIG. 6). However, for example, from the viewpoint of, if the user destination Putar is the stop inadequate point Pia, setting the stop adequate point Pad shifted from the user destination Putar as the vehicle destination Pvtar, the present invention is not limited to this example. For example, when the vehicle 10 has arrived at the vehicle destination Pvtar (S14 in FIG. 3: TRUE), the sliding door 1101 may not be opened automatically.

### [B-2-3. Stop Inadequate Point Pia]

In the above embodiment, the railroad crossing 300, the intersection 500, the construction site, and the periphery thereof are the stop inadequate points Pia (FIG. 5 to FIG. 7). However, for example, from the viewpoint of, if the user destination Putar is the stop inadequate point Pia, setting the stop adequate point Pad shifted from the user destination Putar as the vehicle destination Pvtar, the present invention is not limited to this example. For example, the stop inadequate point Pia may be one or two of the railroad crossing 300, the intersection 500, and the construction site, or the periphery thereof. Alternatively, the stop inadequate point Pia may include a point in a streetcar travel area.

### B-3. Others

In the above embodiment, the flowcharts in FIG. 3, FIG. 4, and FIG. 7 are used. However, the procedure in each flowchart (order of steps) is not limited to the described one as long as the effects of the present invention can be obtained. For example, the combination of steps S31 to S34 and the combination of steps S35 to S38 in FIG. 7 may be opposite.

### C. Reference Signs List

10 vehicle
12 travel control device
22 navigation device
34 HMI (destination input unit)
78 first map DB
82 vehicle destination calculation unit
1101 sliding door (automatic door)
208 travel control unit
210 trajectory generation unit
300 railroad crossing
500 intersection
Pad stop adequate point
Pia stop inadequate point
Putar User destination
Pvtar Vehicle destination

1. A travel control device comprising one or more processors, wherein the one or more processors:
set a vehicle destination where a vehicle stops on the basis of a user destination that is input by a user through a destination input unit; and
cause the vehicle to travel autonomously in at least a part of a route to the vehicle destination,
wherein if it is determined that the user destination is positioned on a road but is a stop inadequate point that is inadequate for the vehicle to stop, on a basis of road information of the user destination, the one or more processors set a stop adequate point that is shifted from the user destination as the vehicle destination.

2. The travel control device according to claim 1, wherein the stop inadequate point includes a point in a railroad crossing, in an intersection, in a construction site, or in a periphery of these places.

3. A vehicle comprising:
a travel control device; and
an automatic door,
wherein the travel control device includes one or more processors, and the one or more processors:
set a vehicle destination where a vehicle stops on the basis of a user destination that is input by a user through a destination input unit; and
cause the vehicle to travel autonomously in at least a part of a route to the vehicle destination,
wherein if it is determined that the user destination is positioned on a road but is a stop inadequate point that is inadequate for the vehicle to stop, on a basis of road information of the user destination, the one or more processors set a stop adequate point that is shifted from the user destination as the vehicle destination, and
wherein if the user destination is the stop inadequate point, the one or more processors set a point where the automatic door faces the user destination as the vehicle destination, and
when the vehicle arrives at the vehicle destination, the one or more processors open the automatic door automatically.

4. A travel control method comprising:
receiving a user destination input by a user through a destination input unit;
setting a vehicle destination where a vehicle stops on a basis of the user destination; and
making the vehicle travel autonomously in at least a part of a route to the vehicle destination,
wherein in the setting the vehicle destination, if it is determined that the user destination is positioned on a road but is a stop inadequate point that is inadequate for the vehicle to stop on a basis of road information of the user destination, a stop adequate point that is shifted from the user destination is set as the vehicle destination.
